(19) United States
(12) Patent Application Publication
(10) Pub. No.: US 2025/0196094 A1
(43) Pub. Date: Jun. 19, 2025

(54) Carbon Nanotube Nano Heaters For Carbon Dioxide Sorbent Systems

(71) Applicant: Chemelectronics LLC, Inglewood, CA (US)

(72) Inventor: Huaping Li, Inglewood, CA (US)

(73) Assignee: Chemelectronics LLC, Inglewood, CA (US)

(21) Appl. No.: 18/544,224

(22) Filed: Dec. 18, 2023

Related U.S. Application Data
(60) Provisional application No. 63/629,952, filed on Dec. 17, 2022.

(51) Int. Cl. B01J 20/20; B01D 53/62; B01D 53/81; B01J 20/18; B01J 20/24; B01J 20/26; B01J 20/28; B01J 20/32

(52) U.S. Cl. CPC B01J 20/205; B01D 53/62; B01D 53/81; B01J 20/186; B01J 20/24; B01J 20/262; B01J 20/28011; B01J 20/28019; B01J 20/3204; B01D 2253/102; B01D 2253/108; B01D 2253/202; B01D 2253/25; B01D 2257/504

(57) ABSTRACT

Heatable carbon sorbent materials, as well as methods for the fabrication thereof, and heatable carbon storage devices incorporating the same are provided. The heatable carbon sorbent materials may comprise a porous scaffold characterized by a microstructure and including a plurality of voids; and a carbon nanotube zeolite material at least partially filling the plurality of voids capable of being heated via application of an electrical current. The porous scaffold may be made of a porous carbon foam. The carbon sorbent materials may include a mixture of a zeolite chemically configured for CO₂ uptake and carbon nanotubes capable of heating via application of an electrical current. The carbon storage devices may be regenerative. The carbon storage devices may be formed as fins or other configurations suitable for use in carbon capture systems.

### CROSS-REFERENCE TO RELATED APPLICATIONS

This application claims priority to U.S. Provisional patent application Ser. No. 18/067,707, filed Dec. 18, 2022, the disclosure of which is incorporated herein by reference.

### FIELD OF THE INVENTION

The current disclosure is directed to carbon nanotube nano heaters and nano fins, methods for the fabrication thereof, and carbon dioxide sorbent systems incorporating the same.

### BACKGROUND OF THE INVENTION

A carbon dioxide scrubber is a piece of equipment that absorbs carbon dioxide (CO₂). It is used to treat exhaust gases from industrial plants or from exhaled air in life support systems such as rebreathers or in spacecraft, submersible craft or airtight chambers. Carbon dioxide scrubbers are also used in controlled atmosphere (CA) storage. They have also been researched for carbon capture and storage as a means of combating climate change.

### SUMMARY OF THE INVENTION

Embodiments of the current disclosure is directed to carbon nanotube heaters and fins, methods for the fabrication thereof, and carbon dioxide sorbent systems incorporating the same.

Many embodiments of the disclosure are directed to heatable carbon capture sorption elements including:
a conductive substrate;
a composite carbon capture material coating having disposed on the conductive substrate, the carbon capture material comprising at least a high surface-area carbon capture material capable of chemically absorbing at least carbon dioxide and having carbon nanotubes integrated therewith; and
a power supply electrically connected with the conductive substrate;
wherein application of a current from the power supply to the conductive substrate results in resistive heating of the carbon capture material through the carbon nanotube nano heater.

In still many embodiments, the conductive substrate is a high surface area substrate selected from carbon foam and metal mesh.

In yet many embodiments, the high surface-area carbon capture material is selected from carbon zeolites, mesoporous silica, carbon-based materials, porous organic polymers, metal oxides, and hybrid materials such as metal-organic frameworks (MOFs).

In still yet many embodiments, the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

In yet still many embodiments, the high surface-area carbon capture material further comprises sodium alginate in a concentration of from 10 to 40 wt. %.

In still yet many embodiments, the high surface-area carbon capture material is dispersed within the coating such that an average distance between zeolites is between 0.5 and 5 μm.

In yet still many embodiments, the high surface-area carbon capture material comprises calcium alginate polymer beads.

In yet still many embodiments, the high surface-area carbon capture material comprises a mixture of PEI modified zeolite and carbon nanotubes.

In still yet many embodiments, the high surface-area carbon capture material further comprises up to 30% by weight of sodium alginate.

In yet still many embodiments, wherein the application of a current from the power supply is capable of heating the carbon capture sorption element to a minimum temperature of 220° C.

Various embodiments of the disclosure are directed to carbon capture material pastes including:
a mixture of carbon nanotubes and a high surface-area carbon capture material selected from carbon zeolites, mesoporous silica, carbon-based materials, porous organic polymers, metal oxides, and hybrid materials such as metal-organic frameworks (MOFs);
wherein the high surface-area carbon capture material is dispersed within the paste such that there is a distance of 0.5 to 5 μm between high surface area carbon capture material particles.

In still various embodiments, the mixture further comprises sodium alginate in a concentration of from 10 to 40 wt %.

In yet various embodiments, the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

In still yet various embodiments, the carbon capture material has a conductivity of between 100 and 400 Ohms with a measured distance of 2 inches.

Some embodiments are directed to methods of forming a heatable carbon capture sorption element including:
forming a composite carbon capture material mixture comprising carbon nanotubes and a carbon capture material comprising at least a high surface-area carbon capture material capable of chemically absorbing at least carbon dioxide;
coating a conductive substrate with the mixture; and
electrically connecting a power supply with the conductive substrate;
wherein application of a current from the power supply to the conductive substrate results in resistive heating of the carbon capture material through the carbon nanotubes.

In still some embodiments, the conductive substrate is a high surface area substrate selected from carbon foam and metal mesh.

In yet some embodiments, the high surface-area carbon capture material is selected from carbon zeolites, mesoporous silica, carbon-based materials, porous organic polymers, metal oxides, and hybrid materials such as metal-organic frameworks (MOFs).

In still yet some embodiments, the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

In yet still some embodiments, the high surface-area carbon capture material further comprises sodium alginate in a concentration of from 10 to 40 wt. %.

In still yet some embodiments, the application of a current from the power supply is capable of heating the carbon capture sorption element to a minimum temperature of 220° C.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIG. 1 provides a flow chart of a process for forming carbon capture systems in accordance with various embodiments.

FIG. 2 provides thermogravimetric data for PEI modified zeolites with carbon nanotube composites in accordance with various embodiments.

FIG. 3 provides SEM images of PEI modified zeolites with carbon nanotube composites in accordance with various embodiments.

FIG. 4 provides computerized tomography of carbon foam coated with carbon nanotubes (left) and photographic images of such materials (right) in accordance with various embodiments.

FIG. 5 provides photographic image of the infra-red heating video of carbon foam coated with carbon nanotubes in accordance with various embodiments.

FIG. 6 provides photographic images of printed ZeoBen, ZeoBen/carbon nanotube, and ZeoBen/graphite lattices formed in accordance with various embodiments.

FIG. 7 provides a plot of the measured electric resistance against carbon nanotube weight per gram of ZeoBen.of printed ZeoBen/Carbon nanotube lattices in accordance with various embodiments.

### DETAILED DISCLOSURE

The embodiments of the invention described herein are not intended to be exhaustive or to limit the invention to precise forms disclosed. Rather, the embodiments selected for description have been chosen to enable one skilled in the art to practice the invention.

Turning to the drawings, schemes, and data, embodiments of heatable carbon sorbent materials, as well as methods for the fabrication thereof, and heatable carbon storage devices incorporating the same are provided. In many embodiments, the heatable carbon sorbent materials comprise a porous scaffold characterized by a microstructure and comprising a plurality of voids; and a carbon nanotube zeolite material at least partially filling the plurality of voids capable of being heated via application of an electrical current. In many embodiments, the porous scaffold is made of a porous carbon foam. In many embodiments, the carbon sorbent materials may comprise a mixture of a zeolite chemically configured for CO₂ uptake and carbon nanotubes capable of heating via application of an electrical current. In many embodiments, the carbon storage devices may be regenerative. In many embodiments, the carbon storage devices are formed as fins or other configurations suitable for use in carbon capture systems.

In many exemplary embodiments carbon capture materials comprise zeolite 13X/PEI800/carbon nanotube polymer gels with printable viscosity and well-dispersed zeolite 13X. Many exemplary embodiments of heatable carbon capture elements may comprise various carbon foam and metal meshes as embedded electrodes that are coated with zeolite13X/PEI800/carbon nanotubes polymer gel carbon capture materials. In many other embodiments, heatable carbon capture elements may comprise printed monolithic lattices of ZeoBen/carbon nanotube paste carbon capture materials. Many embodiments of the zeolite 13X/PEI800/carbon nanotube polymer gel coated carbon foams and metal mesh carbon capture elements show suitable electric conductivity for use as nano heaters and nano fins in sorbent systems. Many embodiments of the ZeoBen/carbon nanotube lattice carbon capture materials show much improved electric conductivity over conventional ZeoBen/conductive carbon black. Exemplary embodiments of carbon capture nano heaters and nano fins demonstrate heating from room temperature to 100° C. at low energy (about 0.4 watts hour), and cooling to room temperature within 2 minutes under ambient condition, demonstrating excellent thermal conductivity of the carbon nanotube nano heaters of such embodiments. Exemplary carbon capture materials also are formed as beads with carbon nanotubes embedded through ionotropic gelation of alginate sodium with CaCl₂).

Spacecraft carbon dioxide (CO₂), water, and trace contaminant (organics) removal systems must be regenerable and reliable and minimize resupply and equivalent system mass (ESM). In most sorbent systems, heat is used to regenerate the beds by expelling contaminants for disposal or to downstream processes for resource recovery. In future deep space exploration missions, such as those to the Moon and to Mars, sorption systems must drastically reduce power to minimize the dependence on scarce resources. The state-of-the-art (SOA) spacecraft sorption systems utilize commercial off-the-shelf (COTS) resistive heaters coupled with conductive fins. These Joule heating methods lead to inefficiencies such as high thermal contact resistance, high temperature differential within the sorption beds, high component mass and volumes, and long ramp-up times. The SOA cooling options utilize blowers, cooling channels or cold plates in conjunction with spacecraft liquid cooling loops. Since spacecraft cooling systems are limited in capacity, efficient cooling methods are also needed. Although it is recognized that the conductivity of the sorbent material is the limiting factor to the heating of sorption beds, it is also important to design integrated thermal management systems that transfer the heat quickly, uniformly, and efficiently throughout the bed. Ideal thermal management components would function both as heaters and coolers. This would lead to reduced system mass and volume of heaters, fin stock, cooling channels, various supporting hardware, and sorption materials.

Improving sorbent systems is also relevant to Human Exploration and Operations Mission Directorate (HEOMD), especially Environmental Control and Life Support Systems (ECLSS), by improving thermal management systems to minimize loading on facility resources such as power, heater, and cooling systems. In addition, efficient heaters minimize mass, power, and volume. The following ECLSS systems could benefit from improvements in thermal management technology: the Atmosphere Revitalization Systems (ARSs), the Water Management Systems, and Solid Waste Management Systems including trash compaction. Other technical areas that may have interest are small satellites and the extravehicular activity (EVA).

Current and future human exploration missions also require regenerable systems that minimize mass, power, volume, and resupply and are highly reliable. Most SOA sorption systems in the Atmosphere Revitalization System (ARS) use COTS heaters that are inefficient, leading to high power requirements. Thermal management in systems such as the Carbon Dioxide Removal Assembly and the Sabatier could be improved by using advanced heating systems. Unfortunately, while innovative heaters such as heat pipes and vapor chambers have been used elsewhere in space hardware but have yet to be developed for use in Environmental Control and Life Support Systems (ECLSS). In addition, a significant amount of the spacecraft power is allocated to a variety of ECLSS. Alternative thermal management approaches that have multiple functions such as heating, cooling, thermal energy storage, and the thermal energy transfer over long distances will drastically reduce the loading on available resources for both in-transit and planetary base missions. These advanced heaters can be used for other NASA mission architectures as well, such as the extravehicular activity (EVA) and the Trash Compaction Processing System.

Many embodiments of the disclosure are directed to sorbent systems having carbon nanotube materials bound and embedded into the sorbent media such that the carbon nanotubes operate simultaneously as resistive heaters and conductive fins to form advanced heaters with both excellent thermal and electrical conductivities to reduce the contact resistance between the heaters and the sorbent media and minimize both heating and cooling rates compared to the SOA heaters. Various embodiments are also directed to facile methods of forming sorbent system materials by forming homogenous mixtures of carbon nanotubes and suitable CO₂ sorbents (such as, for example, zeolites like Z13X/PEI800, and ZeoBen paste) which can then be additively manufactured within sorbent beds to achieve temperature uniformity. The stable chemical properties of carbon nanotubes in accordance with various embodiments allow for the tolerance to corrosion and continuous operation at temperature as high as 200° C. or above to swing sorption systems 24 hours a day.

Carbon nanotube enabled advanced heaters in accordance with many embodiments can minimize the size, mass, power, volume and resupply of these systems while increasing reliability. By embedding the carbon nanotubes into the sorbent medias and dispersing the highly conductive carbon nanotubes throughout the formulation in accordance with many embodiments it is possible to improve the thermal energy transfer efficiency and thermal gradient of the sorption system. Moreover, the thermal mass of the carbon nanotube and other components in the formulation would be relatively small compared to the sorbent (i.e. minimal power to heat compared to a cartridge heater). As will be discussed in greater detail below, such improved carbon nanotube embedded and enable sorption heater systems can be used in the Carbon Dioxide Removal Assemblies (CDRA) on for years of continuous operation.

In accordance with various embodiments carbon dioxide sorption systems are formed of one or more carbon dioxide sorption elements that may be placed into an appropriate carbon dioxide source streams. These carbon dioxide sorption elements may be of any nature, number and shape appropriate for the specific application and carbon dioxide stream. In various embodiments, the elements are formed of a high surface area material, such as for example, foams or meshes formed of carbon or metal, to reduce the overall footprint of the system and increase the amount of carbon dioxide that can be captured by the elements. Although any suitable high surface area material may be used to form the carbon capture elements in various embodiments the elements are formed of a suitable carbon foam.

Regardless of the shape and configuration of the carbon dioxide capture elements, the elements are coated with a suitable heatable high surface area carbon capture material comprising at least a mixture of at least one high surface capture material and a carbon nanotube material. Many suitable high surface area carbon capture materials are known and can be used in accordance with embodiments, including, for example, carbon zeolites, mesoporous silica, carbon-based materials, porous organic polymers, metal oxides, and hybrid materials such as metal-organic frameworks (MOFs). In various embodiments these materials may include surface or chemical treatments to enhance the uptake of carbon dioxide. Some embodiments of high surface area carbon capture materials incorporate suitable amine moieties to increase carbon dioxide uptake rates, including, but not limited to polyethylenimine (PEI), diethanolamine (DEA), aminomethyl propanol (AMP), isopropylamine (IPA), ethanolamine (MEA), and ethylenediaminonaphthalene (EDAN), etc., and mixtures thereof. The amine moieties may be included at any concentration suitable for the specific carbon capture application.

The carbon capture materials further incorporate carbon nanotubes dispersed therein to provide resistive heating to the carbon capture material. Any suitable carbon nanotubes may be used in accordance with embodiments including, single or multi-walled carbon nanotubes, of any suitable chirality or conformation. The carbon nanotubes may be included in any concentration suitable to ensure sufficient conductive characteristics for the application of Ohmic heating to the overall carbon capture element. In various embodiments, the carbon nanotubes are included in a concentration such that the average conductivity over a measured distance of 1 to 3 inches is from 100 to 300 Ohms. As will be discussed in greater detail below, in various embodiments the carbon capture material and carbon nanotubes may be included in a one to one ratio.

Carbon capture materials may also be blended with other auxiliary materials suitable for placing the zeolites into solution together or making them solution suitable for the specific applications (e.g., having a printable viscosity) and ensuring well-dispersed zeolites (˜0.5 to 5 μm) with incorporated carbon nanotubes. For example, various embodiments include sodium alginate to form a viscous gel and CaCl₂) to precipitate beads of the carbon capture materials, etc. Although specific examples of materials are provided here, it will be understood that variants to these materials or additional auxiliary materials may be considered that will not change the underlying heatability properties of the combined high surface area carbon capture material and carbon nanotubes. In particular, materials must be selected that will allow the carbon capture elements to be heated to the deposition temperature of CO₂ and H₂O of between 5° and 200° C. Materials that cannot withstand these temperatures would decompose under the operating conditions of the elements and thereby not be regenerable.

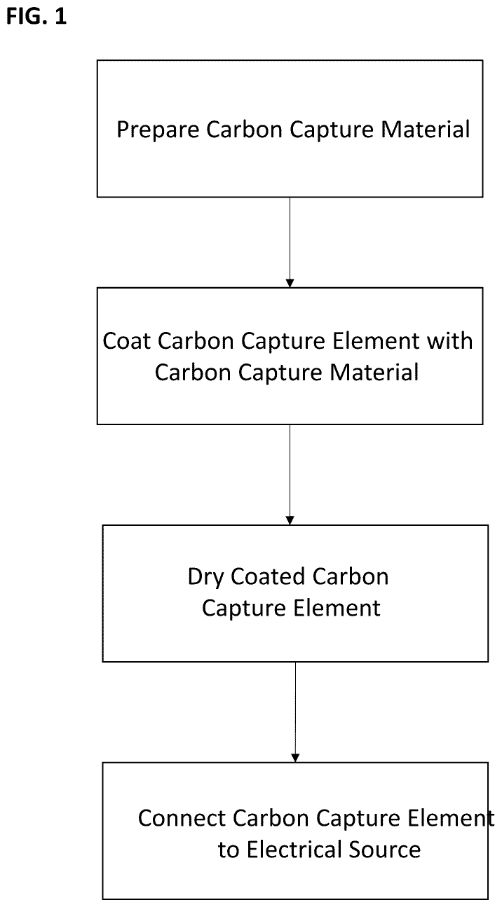

Although the above discussion has focused on materials suitable for use in heatable carbon capture elements, embodiments are also directed to methods of forming such elements. As shown in FIG. 1, in various embodiments the process may include forming a suitable carbon capture material by mixing together at least a high surface area carbon capture material and a solution of carbon nanotubes, coating the carbon capture material onto a suitable carbon capture element, and drying the carbon capture element. These carbon capture elements are then incorporated into a larger carbon capture system including a power supply to provide electrical current across the carbon capture element. Further details of the process will be described in greater details in the exemplary embodiments below.

### EXEMPLARY EMBODIMENTS

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is number average molecular weight, temperature is in degrees Celsius, and pressure is at or near atmospheric.

In an embodiment of the carbon capture materials and systems discussed above a carbon capture material comprising zeolite 13X and branched polyethyleneimine (PEI800) (60% loading) alginate polymer gel with fluffy carbon nanotubes is explored as nanoscale heaters and fins that are capable of being printed and coated on electrically and thermally conductive, porous carbon foams and metal meshes as embedded electrodes. In another alternative, ZeoBen (zeolite blended with inorganic binder Bentonite clay) was also formulated with carbon nanotubes and printed to monolith lattices following high temperature curing. As will be discussed in greater detail, embodiments of carbon capture materials incorporating carbon nanotubes, either coated or printed) exhibit much improved electric conductivity over those without carbon nanotubes. Carbon foam nano-fin carbon capture elements coated with embodiments of such carbon nanotube enable carbon capture materials were further demonstrated for the fast heating from room temperature to 100° C. within 1 minute supplied with 10 V, 2A DC current, and fast cooling from 100° C. to room temperature in about 2 minutes, indicating excellent resistive heating and thermal conductivity. The developed printable polymer carbon capture material is also demonstrated as being able to form spheric beads embedded in carbon foams when alginate sodium was gelated with CaCl₂. The polymer beads with microscopic structures allow for good vapor permeability through adsorbent bed. Embodiments are also demonstrated for host zeolite 13X and PEI800 CO₂ absorbers as well as for embodiments incorporating hygroscopic salts for water absorption. Such embodiments demonstrate that carbon nanotube enabled composite carbon capture materials and sorbent elements powered with electricity can generate resistive heat via the dispersed carbon nanotubes and directly transport the heat to its guest's zeolite 13X and PEI800 to remove CO₂ and water for regeneration. With the application of carbon nanotubes inside the sorbent systems, the regeneration temperature and thermal gradient are reduced, which leads to lower power consumption and materials sustainability.

### Materials and Methods

Formulate zeolite 13X/PE1800 polymer gel with carbon nanotubes. In various exemplary embodiments an ionotropic gelation of a sodium alginic acid solution with Ca²⁺ was formed by adding CaCl₂), a hygroscopic salt to form polymer beads with porous structure as scaffold of CO₂ sorbent materials zeolite 13X/PEI800. (See, e.g., Paul A. Kallenberger, and Michael Froba. Communications Chemistry 1, No. (2018): 28, the disclosure of which is incorporated herein by reference.) In such embodiments, the alginate gel solution will form sphere beads through ionotropic gelation with CaCl₂) (hygroscopic salt) embedded in pores of carbon foams. The hygroscopic salts CaCl₂) also can adsorb water moisture. This will make sorbent bed hydrothermally and mechanically stable. The macroscopic structure of alginate will yield equivalent system mass reduction due to better thermal and fluid management and mass transfer properties, to minimize pressure drop, provide large surface area for mass transfer, and prevent channeling. Carbon nanotubes stuck inside the zeolite 13X/PEI800 polymer beads will contact with these carbon foams. The ratio of zeolite 13X to PEI800 can be adopted from literature, as discussed in greater detail below, with optimized 60% loading of PEI800. The ratio of zeolite 13X/PEI800 combination to sodium alginate was be optimized based on the balance between CO₂ adsorption capacity and mechanical and hydrothermal stability. In these zeolite 13X/PEI800 polymer gel, fluffy (lightweight and cotton-like) carbon nanotubes were blended inside to serve as resistive heaters that can directly contact with zeolite. Although one zeolite system is describe, as will be understood similar known optimization schemes can be used to design other zeolite/amine systems in accordance with embodiments. (See, e.g., Xiaochun Xu, et al., Energy & Fuels 16, no. (2002): 1463-1469; Wenbin Zhang, et al., Chemical Engineering Journal 251, No. (2014): 293-303; and Swetha Karka, et al., ACS Omega 4, No. (2019): 16441-16449, the disclosures of which are incorporated herein by reference.)

Characterize zeolite 13X/PEI800/alginate polymer pastes incorporating carbon nanotubes heaters. The zeolite 13X/PEI800/alginate polymer composites in accordance with exemplary embodiments, were imaged with scanning electron microscope for macroscopic structure and analyzed using thermogravimetric analysis for CO₂ and water adsorption.

Coat and characterize zeolite 13X/PEI800/carbon nanotubes polymer gel on carbon foams and metal meshes. Zeolite 13X/PEI800/carbon nanotube polymer gel carbon capture materials in accordance with embodiments were coated on carbon foams and metal meshes that will serve as embedded electrodes for power supply. The electricity conductivity of these zeolite 13X/PEI800/carbon nanotubes polymer gel coated carbon foams and metal meshes could then be measured and compared. The distribution of zeolite 13X/PEI800/carbon nanotubes inside carbon foams was imaged with X-Ray computed tomography.

Test advanced carbon nanotubes heater. The carbon nanotube coated carbon foam sorbent elements according to the exemplary embodiments, were tested for heating and cooling at ambient environment by supplying DC current. The heating and cooling processes were imaged with an FLIR camera.

Formulate ZeoBen/carbon nanotubes paste. In another exemplary embodiment a ZeoBen paste (zeolite 13X powders (94 wt %), bentonite clay (4.2 wt %, inorganic binder), methyl cellulose (MC, 1.2 wt %, plasticizing organic binder) and poly (vinyl) alcohol (PVA, 0.6 wt %)) carbon capture material was formulated. To the prepared ZeoBen paste, different concentration of carbon nanotubes was added. For comparison, the electric conductive graphite powder was added into ZeoBen paste.

Print and Characterize ZeoBen/carbon nanotubes monoliths lattice To demonstrate the printability of exemplary embodiments of carbon capture materials, the formulated ZeoBen/carbon nanotubes paste (ZeoBen/graphite paste) was pressure-injected into lattice structure and annealed with heat gun at 537° C. The electricity conductivity of cured ZeoBen/carbon nanotubes (graphite) monoliths lattices were measured.

### Formulating Carbon Capture Materials

As discussed above, many different combinations of the high surface area carbon capture materials and carbon nanotubes to provide resistively heatable carbon capture elements are possible in accordance with embodiments. Various embodiments incorporate zeolite X13 with PEI modification as the high surface are carbon capture material. Zeolite X13 modified with PEI has been shown to provide robust carbon dioxide uptake across various concentrations. For example, a zeolite X13 material with 60% PEI800 (by weight) can uptake >200 mg CO₂ per gram materials. Accordingly, in various embodiments zeolite X13/PEI800 (60% weight) paste is formulated. To this zeolite X13/PEI800 high surface area carbon capture materials various concentrations of alginate sodium (e.g., 10%, 20%, 30% and 40% weight alginate sodium) were added respectively to form compositions with different viscosity characteristics. These compositions (zeolite X13/PEI800 (60% weight), with 10%, 20%, and 30% weight alginate sodium) were further blended with a carbon nanotube powder until the compositions were completely dry. Zeolite X13/60% W PEI800 with 40% alginate sodium is already dry and therefore cannot be blended with the carbon nanotube powder. A high surface area carbon capture materials comprising a zeolite X13 (50% weight) and carbon nanotube water paste (50% weight) was also mixed to form zeolite X13/carbon nanotube water paste. In short, by mixing high surface are carbon capture materials (e.g., X13/PEI800) with carbon nanotubes and or carbon nanotubes and polymer gels it is possible to form a carbon capture materials with a printable viscosity and a well-dispersed zeolite.

### Characterizing Carbon Capture Materials

Exemplary embodiments of zeolite13X/PEI800/carbon nanotube polymer gel carbon capture materials were characterized with TGA to determine the decomposition temperature of different materials and SEM to illustrate the homogenously blending of carbon nanotubes and zeolite 13X.

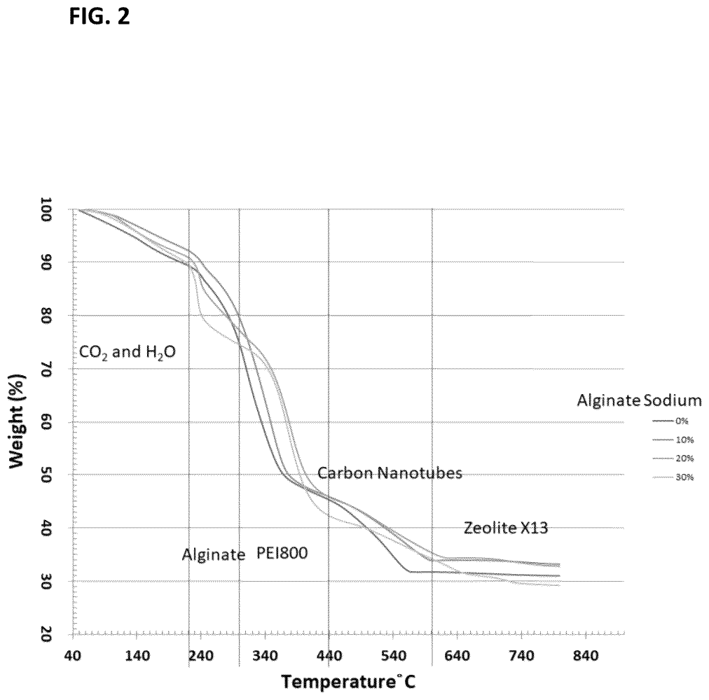

As previously discussed carbon capture materials according to embodiments must be stable to temperatures (˜50-220° C.) such that the materials can be regenerated without decomposition. In various embodiments carbon capture materials comprising zeolite X13/PEI800/carbon nanotube polymer beads were formed and these composites were analyzed with thermograveric analysis (TGA), as shown in FIG. 2. (See, e.g., Li, K., et al., Applied Energy, Vol. 136, 2014, pp. 750-755, the disclosure of which is incorporated herein by reference.) The TGA tests were conducted on samples composed of 10% CO₂ and H₂O in the temperature range of 50 to 220° C. which is consistent with literature report (Li, K. et al. Applied Energy, 2014, 136, 750-755). As shown, in the data all of the elements of the carbon capture materials are stable within the target temperature range. Specifically, the decomposition of Alginate Sodium is in the temperature range of 220 to 300° C., PEI800 decomposed in the temperature range of 240 to 440° C., and the carbon nanotubes decomposed in the temperature range of 440 to 600° C.

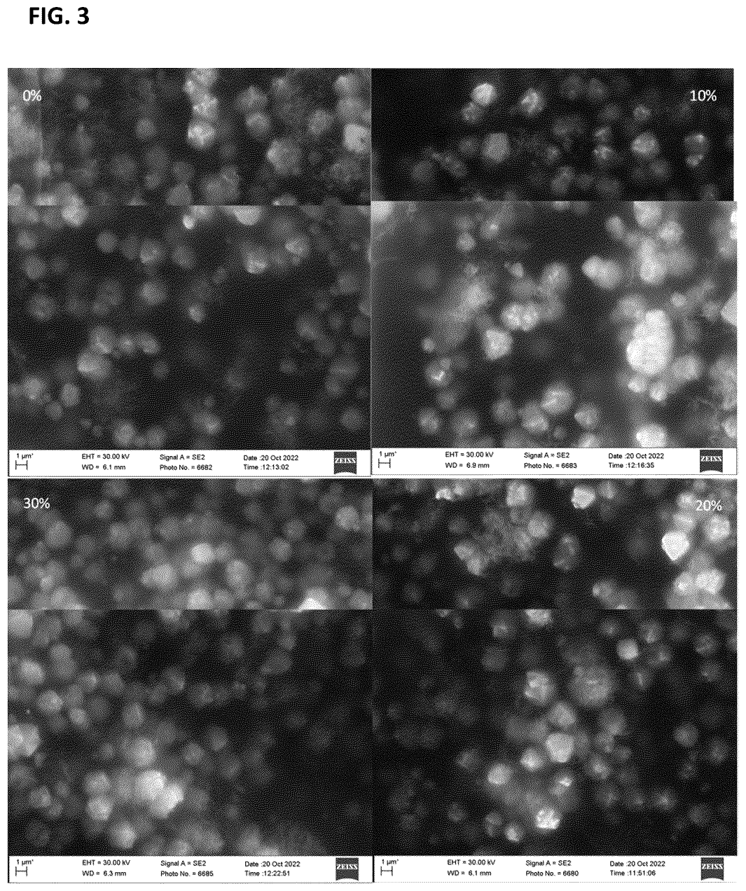

In addition, exemplary carbon capture materials (X13/PEI800/Alginate Sodium/Carbon Nanotubes) were imaged with scanning electron microscope (SEM) to demonstrate the sufficient microstructure of calcium alginate polymer beads (0%) and uniformly distributed zeolite X13/PEI800/Carbon Nanotubes inside calcium alginate polymer beads (10%, 20%, 30% by weight) formed from a carbon capture formula of zeolite X13/PEI800/carbon nanotube polymer gel with printable viscosity. These SEM images clearly show well distributed Zeolite X13 (around 2 μm) contacted with carbon nanotubes (FIG. 3) across all concentrations in accordance with exemplary embodiments.

### Forming Carbon Capture Elements

Embodiments are also directed to coating carbon capture elements with carbon capture materials. In various embodiments zeolite X13/60% w/PEI800/20% w/alginate sodium carbon nanotube polymer gel carbon capture materials were coated on conductive carbon foam (100 PPI pore size). The carbon capture materials (zeolite X13/carbon nanotubes paste) were formulated (as previously described) by mixing 20 gram zeolite X13 and 20 gram carbon nanotube water slurry. The carbon capture material paste thus formed was coated on both conductive carbon foam (100 PPI pore size) and metal mesh. These results demonstrate the zeolite 13X/PEI800/Carbon Nanotubes polymer gel can be easily coated on different substrates.

The conductivity of zeolite X13/carbon nanotubes paste coated carbon foam and metal mesh were measured with a multimeter. Their average conductivity is around 200 Ohms with a measured distance of around 3 inches on the carbon foam and 120 Ohms with a measured distance of 2 inches on the metal meshes. The results show good electric conductivity within operable range for all heatable carbon capture elements in accordance with exemplary embodiments.

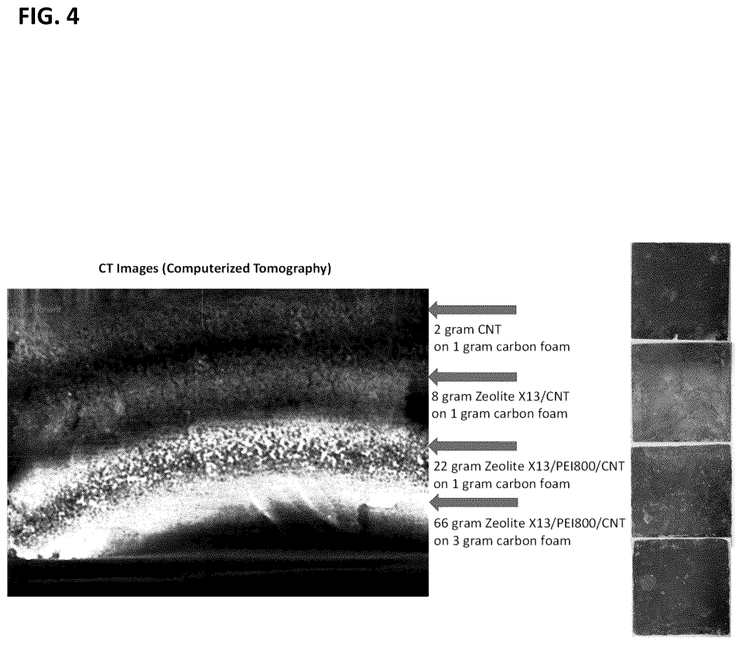

To determine adhesion of the carbon capture material with the carbon capture heat element, 2 gram of carbon nanotubes were coated onto 100 pore per inch carbon foam with dimension of 2 inch×2 inch×0.125 inch carbon form as a control, and 8 grams of Zeolite X13/carbon nanotubes were coated onto 100 pore per inch carbon foam with dimension of 2 inch×2 inch×0.079 inch carbon foam, and 22 and 66 grams of ZeoliteX13/PEI800/carbon nanotubes were coated onto 100 pore per inch carbon foam with dimension of 2 inch×2 inch×0.079 inch carbon foam and 20 pore per inch carbon foam with dimension of 2 inch×2 inch×0.25 inch carbon foam, respectively. These carbon capture elements were imaged with x-ray computerized tomography shown in FIG. 4. As observed, carbon nanotubes are hardly differentiated from porous carbon foam, while the Zeolite X13 forms a more concrete solid inside the carbon foam (the white images show the zeolites containing the organic PEI800 polymer). These results demonstrate the integration of the carbon nanotube with the carbon element by a simply coating deposition technique is possible to form a lightweight CO₂ sorbent carbon foam bed (<330 Kg/0.3 m³, >29.04 Kg CO₂/0.3 m³, 198 Kg water/0.3 m³) in accordance with embodiments.

### Operation of Heatable Carbon Capture Elements

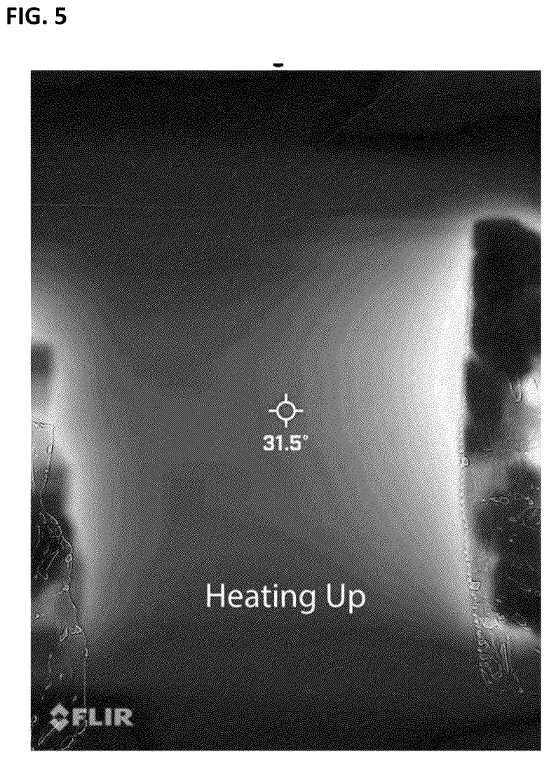

To demonstrate CO₂ and water removal from CO₂ sorbent carbon capture element in accordance with embodiments, a carbon capture foam element as described above was integrated with a power source for in-situ heat generation. Although any power supply suitable for the application may be used, in this example a power source supplying 12 V, 2A DC power was utilized. The heater was able to heat up from room temperature to over 100° C. within 1 minute at under 10 voltage and 2 Ampere DC power supply (20 Watts) and cooled down to room temperature about 2 minutes under an ambient environment (e.g., no supplemental cooling). The heating and cooling processes were recorded with an FLIR Infra-Red camera as presented in FIG. 5. These heating and cooling rates are much faster than the state of the art 60 minutes require for heating up from 20 to 200° C. and about 120 minutes cooling down from 60° C. to room temperature for conventional 4BCO2 bed systems (average 272 Watts power). (See, e.g., Schunk, R. G., et al., In International Conference on Environmental Systems (No. ICES-2017-256); Coker, R. F., et al., In International Conference on Environmental Systems (No. ICES-2015-160); Richardson, T. M. J., Jan, D., 2018 July. In International Conference on Environmental Systems (No. ICES-2018-332), the disclosures of which are incorporated herein by reference.) More interestingly, exemplary embodiments of carbon nanotube enable nano heaters directly cooled down at room temperature. This indicates many embodiments of the carbon nanotube enabled nano heaters can be reused after heating regeneration without any additional need for a cold sink. This study demonstrates that carbon capture elements in accordance with embodiments are capable of heating and cooling using an in-situ heating source of low power thereby simplifying and reducing the cost of regeneration of these sorption elements.

### Printable Carbon Capture Materials

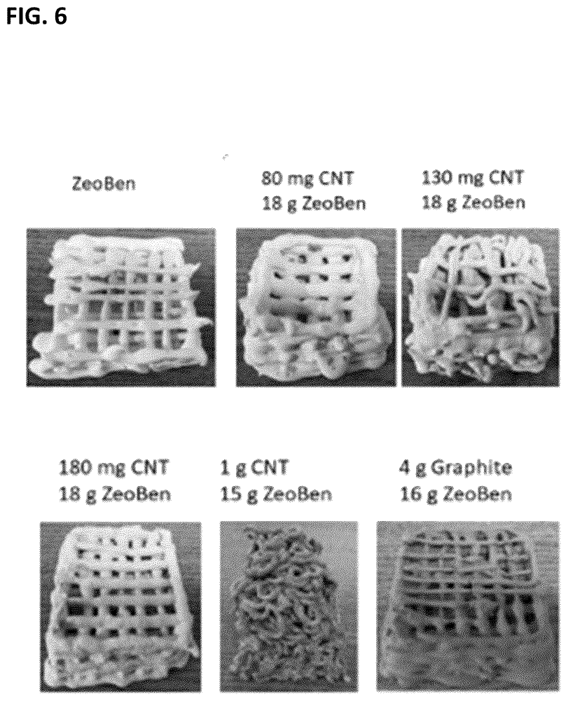

Various exemplary embodiments are also directed to printable carbon capture materials. In several such embodiments ZeoBen paste was formulated by mixing zeolite 13X powders (94 wt %), bentonite clay (4.2 wt %, inorganic binder), methyl cellulose (MC, 1.2 wt %, plasticizing organic binder) and poly (vinyl) alcohol (PVA, 0.6 wt %) co-binder in 137-gram de-ionic water to fabricate zeolite monoliths for CO₂ capture. (See, e.g. Thakkar, H., et al., ACS applied materials & interfaces, 8 (41), pp. 27753-27761; Cesarano III, et al., In International Conference on Environmental Systems (No. ICES-2022-381); and Steppan, J., et al., In International Conference on Environmental Systems (No. ICES-2022-370), the disclosures of which are incorporated herein by reference) The pastes were then placed in four centrifuge tubes (in exemplary samples of 42 grams). To these centrifuge tubes 13 gram, and 18 gram samples of carbon nanotube paste (1 gram carbon nanotubes in 100 gram de-ionized water) were added, respectively. These ZeoBen/carbon nanotubes were extensively mixed using a spatula. As comparison, the 38 gram ZeoBen paste was mixed with 4 gram conductive graphite (conductive graphite has been widely used as cathode in lithium battery). ZeoBen/carbon nanotubes paste was also formulated with 1 gram of carbon nanotube and 15 grams of ZeoBen power in 15 grams of de-ionized water. These pastes were printed into lattices as shown in FIG. 6.

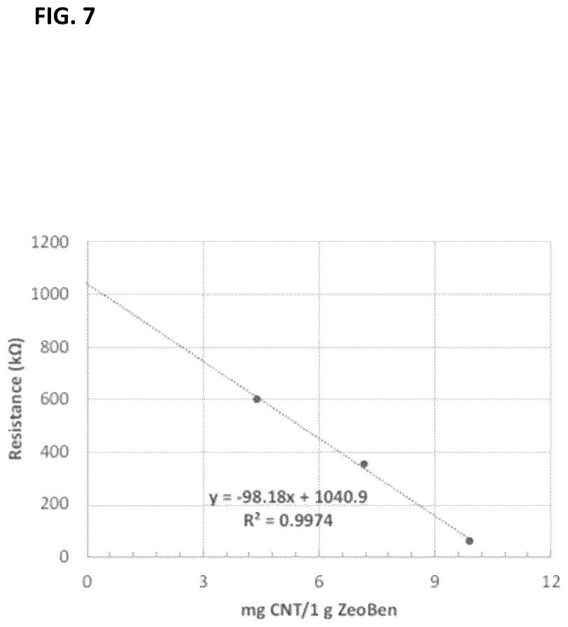

The printed lattices were fired using a heat gun at 537° C. The resistances of these lattices were measured using a multimeter. The resistance of pure ZeoBen lattice could not be measured. The resistances of ZeoBen/carbon nanotubes lattices vary from 601 kΩ, 353 kΩ, to 60.8 kΩ corresponding to added 8 gram, 13 gram, and 18 gram carbon nanotubes pastes. These resistances show very good linear correlation with carbon nanotubes dry weight concentrations, as shown in FIG. 7. The best electric resistance is about 1.168 kΩ for 1 gram carbon nanotubes mixed with 15 gram ZeoBen lattice. This data is much better than 178.5 k (2 for 4 gram graphite/16 gram ZeoBen lattice. These results indicate that embodiments incorporating such ZeoBen monolith lattices could be used to replace Zeolite pellets as CO₂ sorbent in air revitalization systems. Embodiments incorporating the light-weight, electrically and thermally conductive carbon nanotube enabled nano heaters and nano fins would reduce overheating and thermal gradient, and these ZeoBen monoliths could be regenerated more efficiently with low power consumption and with long lifetime sustainability.

### Carbon Capture Bead Materials

Some exemplary embodiments were also directed to Zeolite 13X/PEI800/CNT bead carbon capture materials. In various such embodiments, the Zeolite 13X/PET800/CNT/Sodium Alginate mixture was dropped into CaCl₂) aqueous solution. The black beads were formed and precipitated down with Zeolite 13X/PEI800/CNT. Without Zeolite 13X, the black beads would float on the top surface of aqueous solution. These Zeolite 13X/PET800/CNT embedded in porous alginate calcium polymer beads can absorb both water moisture by hygroscopic CaCl₂) salt and CO₂ by Zeolite 13X/PEI800. The low mass carbon nanotubes according to such embodiments can serve as nano heaters and nano fins for regeneration of water and CO₂ sorption capacity. These Zeolite 13X/PEI800/CNT polymer beads in accordance with many embodiments can replace conventional pellets such as, for example, Grace Davison 544 13X pellets, ASRT 5A pellets, or RK-38 pellets.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A heatable carbon capture sorption element comprising:
a conductive substrate;
a composite carbon capture material coating having disposed on the conductive substrate, the carbon capture material comprising at least a high surface-area carbon capture material capable of chemically absorbing at least carbon dioxide and having carbon nanotubes dispersed therewith; and
a power supply electrically connected with the conductive substrate;
wherein application of a current from the power supply to the conductive substrate results in resistive heating of the carbon capture material through the carbon nanotubes.

2. The heatable carbon capture sorption element of claim 1, wherein the conductive substrate is a high surface area substrate selected from carbon foam and metal mesh.

3. The heatable carbon capture sorption element of claim 1, wherein the high surface-area carbon capture material is selected from carbon zeolites, mesoporous silica, carbon-based materials, porous organic polymers, metal oxides, and hybrid materials such as metal-organic frameworks (MOFs).

4. The heatable carbon capture sorption element of claim 1, wherein the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

5. The heatable carbon capture sorption element of claim 1, wherein the high surface-area carbon capture material further comprises sodium alginate in a concentration of from 10 to 40 wt. %.

6. The heatable carbon capture sorption element of claim 1, wherein the high surface-area carbon capture material is dispersed within the coating such that an average distance between zeolites is between 0.5 and 5 μm.

7. The heatable carbon capture sorption element of claim 1, wherein the high surface-area carbon capture material comprises calcium alginate polymer beads.

8. The heatable carbon capture sorption element of claim 1, wherein the high surface-area carbon capture material comprises a mixture of PEI modified zeolite and carbon nanotubes.

9. The heatable carbon capture sorption element of claim 8, further comprising up to 30% by weight of sodium alginate.

10. The heatable carbon capture sorption element of claim 1, wherein the application of a current from the power supply is capable of heating the carbon capture sorption element to a minimum temperature of 220° C.

11. A carbon capture material paste comprising:
a mixture of carbon nanotubes and a high surface-area carbon capture material selected from carbon zeolites, mesoporous silica, carbon-based materials, porous organic polymers, metal oxides, and hybrid materials such as metal-organic frameworks (MOFs);
wherein the high surface-area carbon capture material is dispersed within the paste such that there is a distance of 0.5 to 5 μm between high surface area carbon capture material particles.

12. The carbon capture material of claim 11, wherein the mixture further comprises sodium alginate in a concentration of from 10 to 40 wt %.

13. The carbon capture material of claim 11, wherein the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

14. The carbon capture material of claim 11, wherein the carbon capture material has a conductivity of between 100 and 400 Ohms with a measured distance of 2 inches.

15. A method of forming a heatable carbon capture sorption element comprising:
forming a composite carbon capture material mixture comprising carbon nanotubes and a carbon capture material comprising at least a high surface-area carbon capture material capable of chemically absorbing at least carbon dioxide;
coating a conductive substrate with the mixture; and
electrically connecting a power supply with the conductive substrate;
wherein application of a current from the power supply to the conductive substrate results in resistive heating of the carbon capture material through the carbon nanotubes.

16. The method of claim 15, wherein the conductive substrate is a high surface area substrate selected from carbon foam and metal mesh.

17. The method of claim 15, wherein the high surface-area carbon capture material is selected from carbon zeolites, mesoporous silica, carbon-based materials, porous organic polymers, metal oxides, and hybrid materials such as metal-organic frameworks (MOFs).

18. The method of claim 15, wherein the high surface-area carbon capture material is further modified with an amine selected from polyethylenimine (PEI), diethanolamine (DEA), aminomethyl propanol (AMP), isopropylamine (IPA), ethanolamine (MEA), and ethylenediaminonaphthalene (EDAN), and mixtures thereof.

19. The method of claim 15, wherein the high surface-area carbon capture material further comprises sodium alginate in a concentration of from 10 to 40 wt. %.

20. The methods of claim 15, wherein the application of a current from the power supply is capable of heating the carbon capture sorption element to a minimum temperature of 220° C.
